(19) United States
(12) Patent Application Publication
(10) Pub. No.: US 2022/0340143 A1
(43) Pub. Date: Oct. 27, 2022

(54) METHOD AND DEVICE FOR CALCULATING RUNNING RESISTANCE OF VEHICLE

(71) Applicants: Hyundai Motor Company, Seoul (KR); Kia Corporation, Seoul (KR)

(72) Inventors: Jun Sung PARK, Yongin-si (KR); Jaebin LEE, Yongin-si (KR)

(73) Assignees: Hyundai Motor Company, Seoul (KR); Kia Corporation, Seoul (KR)

(21) Appl. No.: 17/528,775

(22) Filed: Nov. 17, 2021

(30) Foreign Application Priority Data
Apr. 21, 2021 (KR) 10-2021-0051680

(51) Int. Cl. B60W 40/076; B60W 50/06; B60W 10/10

(52) U.S. Cl. CPC B60W 40/076; B60W 50/06; B60W 10/10; B60W 2552/20; B60W 2552/15; B60W 2520/40

(57) ABSTRACT

A method for determining running resistance of a vehicle includes receiving, by a controller, a rotation speed of a driving source of the vehicle and an inclination angle of a road on which the vehicle runs; determining a torque of the driving source according to the rotation speed of the driving source and determining the inclination angle of the road according to the torque of the driving source; determining whether the inclination angle exceeds the inclination angle of the road; determining that there is no object towed by the vehicle, and determining the running resistance of the vehicle based on the inclination angle according to the torque of the driving source, when the inclination angle is less than or equal to the inclination angle of the road; and controlling the driving source or a transmission of the vehicle based on the determined running resistance of the vehicle.

### CROSS-REFERENCE TO RELATED APPLICATION

The present application claims priority to Korean Patent Application No. 10-2021-0051680 filed on Apr. 21, 2021, the entire contents of which is incorporated herein for all purposes by this reference.

### BACKGROUND OF THE INVENTION

### Field of the Invention

The present invention relates to a vehicle. More particularly, the present invention relates to a method and device for determining running resistance of a vehicle.

### Description of Related Art

In general, running resistance refers to a sum of individual resistances generated against running of a vehicle.

The running resistance includes rolling resistance, air resistance, and climbing resistance. The rolling resistance is resistance generated when vehicle's wheels roll on a road surface, the air resistance is resistance generated by an air flow while a vehicle is running, and the climbing resistance is resistance generated by gravity when a vehicle climbs a slanted surface.

The running resistance is a necessary item to predict the performance of a vehicle, and such running resistance may be obtained by use of a simulation or by measuring while the vehicle is actually running.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a method and device configured for determining running resistance of a vehicle having advantages of accurately and rapidly determining the running resistance of the vehicle.

Various aspects of the present invention are directed to providing a method for determining running resistance of a vehicle, including: receiving, by a controller, a rotation speed of a driving source of the vehicle and an inclination angle of a road on which the vehicle runs, the inclination angle being detected by an inclination angle sensor; determining, by the controller, a torque of the driving source according to the rotation speed of the driving source and determining the inclination angle of the road according to the torque of the driving source; determining, by the controller, whether the inclination angle of the road determined according to the torque of the driving source exceeds the inclination angle of the road detected by the inclination angle sensor; determining, by the controller, that there is no object towed by the vehicle, and determining the running resistance of the vehicle based on the inclination angle of the road determined according to the torque of the driving source when the inclination angle of the road determined according to the torque of the driving source is less than or equal to the inclination angle of the road detected by the inclination sensor; and controlling, by the controller, the driving source or a transmission of the vehicle based on the determined running resistance of the vehicle.

The method for determining running resistance of a vehicle may further include: determining, by the controller, that there is the object towed by the vehicle and correcting the inclination angle of the road determined according to the torque of the driving source determined based on the speed of the vehicle when the controller concludes that the inclination angle of the road determined according to the torque of the driving source exceeds the inclination angle of the road detected by the inclination angle sensor; and determining, by the controller, a running resistance of the vehicle based on the corrected inclination angle of the road determined according to the torque of the driving source.

The correcting of the inclination angle of the road determined according to the torque of the driving source may include increasing, by the controller, the inclination angle of the road determined according to the torque of the driving source by a reference inclination angle when the speed of the vehicle is greater than or equal to a reference value.

The value of the reference inclination angle may increase when a magnitude of an air resistance force of the towed object increases.

Various aspects of the present invention are directed to providing an apparatus configured for determining running resistance of a vehicle, including: a driving source rotation speed sensor configured for detecting a rotation speed of a driving source included in the vehicle; an inclination angle sensor configured for detecting an inclination angle of a road on which the vehicle runs; and a controller that receives the rotation speed of the driving source detected by the driving source rotation speed sensor and the inclination angle of the road detected by the inclination angle sensor, in which the controller may be configured to determine a torque of the driving source according to the rotation speed of the driving source, and determine the inclination angle of the road according to the torque of the driving source, the controller may be configured to determine whether the inclination angle of the road determined according to the torque of the driving source exceeds the inclination angle of the road detected by the inclination angle sensor, when the controller concludes that the inclination angle of the road determined according to the torque of the driving source is less than or equal to the inclination angle of the road detected by the inclination sensor, the controller may be configured to determine that there is no object towed by the vehicle, and determine the running resistance of the vehicle based on the inclination angle of the road determined according to the torque of the driving source, and the controller may be configured to control the driving source or a transmission of the vehicle based on the determined running resistance of the vehicle.

When the inclination angle of the road determined according to the torque of the driving source exceeds the inclination angle of the road detected by the inclination angle sensor, the controller may be configured to determine that there is the object towed by the vehicle, and correct the inclination angle of the road determined according to the torque of the driving source determined based on the speed of the vehicle detected by the vehicle speed sensor, and the controller may be configured to determine the running resistance of the vehicle based on the corrected inclination angle of the road determined according to the torque of the driving source.

When the controller concludes that the speed of the vehicle is equal to or greater than the reference value, the controller may increase the inclination angle of the road determined according to the torque of the driving source by the reference inclination angle to correct the inclination angle of the road based on the torque of the driving source.

The value of the reference inclination angle may increase when a magnitude of an air resistance force of the towed object increases.

The above-described method and apparatus configured for determining running resistance of a vehicle according to various exemplary embodiments of the present invention may accurately and rapidly determine running resistance of a vehicle in real time.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

A brief description of the drawings will be provided to allow the drawings used in a detailed description of the present invention to be sufficiently understood.

FIG. 1 is a flowchart illustrating a method for determining running resistance of a vehicle according to various exemplary embodiments of the present invention.

FIG. 2 is a diagram for describing a device configured for determining running resistance of a vehicle to which the method for determining running resistance of a vehicle illustrated in FIG. 1 is applied.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments, it will be understood that the present description is not intended to limit the present invention(s) to those exemplary embodiments. On the other hand, the present invention(s) is/are intended to cover not only the exemplary embodiments, but further various alternatives, modifications, equivalents and other embodiments, which may be included within the spirit and scope of the present invention as defined by the appended claims.

To sufficiently understand the present invention and objects accomplished by executing the present invention, reference should be made to the accompanying drawings illustrating exemplary embodiments of the present invention and contents described in the accompanying drawings.

Hereinafter, the present invention will be described in detail by describing exemplary embodiments of the present invention with reference to the accompanying drawings. In describing the present invention, well-known configurations or functions will be omitted in detail since they may unnecessarily obscure the gist of the present invention. Throughout the drawings, the same reference numerals will denote the same components.

Terms used in the present specification are used only to describe specific exemplary embodiments rather than limiting the present invention. Singular forms are to include plural forms unless the context clearly indicates otherwise. It will be further understood that the terms “include” or “have” used in the present specification, specify the presence of features, numerals, steps, operations, components, parts mentioned in the present specification, or a combination thereof, but do not preclude the presence or addition of one or more other features, numerals, steps, operations, components, parts, or a combination thereof.

Throughout the present specification, when any one portion is referred to as being “connected to” another portion, it means that any one portion and another portion are “directly connected to” each other or are “electrically or mechanically connected to” each other with the other component interposed therebetween.

Unless being defined otherwise, the terms used in the present specification including technical and scientific terms have the same meanings as those that are generally understood by a person of ordinary skill in the art. It should be understood that the terms defined by the dictionary are identical with the meanings within the context of the related art, and they should not be ideally or excessively formally defined unless the context clearly dictates otherwise.

A method for determining running resistance of a vehicle provided with a trailer according to the related art determines the running resistance of the vehicle using a weight of the vehicle according to a physical theoretical formula, so it is not possible to accurately and rapidly determine the running resistance of the vehicle in real time. Factors of the physical theoretical formula include an inclination angle (inclination angle of a vehicle) of a road on which the vehicle runs and an acceleration) of the vehicle speed over time, which makes the running resistance of the vehicle inaccurate. Therefore, when the inclination angle approaches 0 and the acceleration approaches 0, a denominator of the physical theoretical formula approaches (converges) 0, and the weight of the vehicle according to the physical theoretical formula becomes infinite, so that the weight of the vehicle cannot be determined.

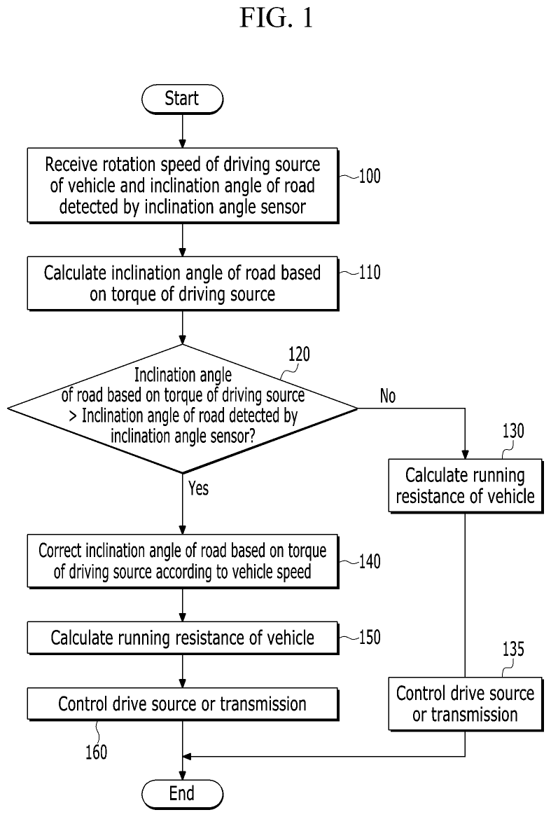

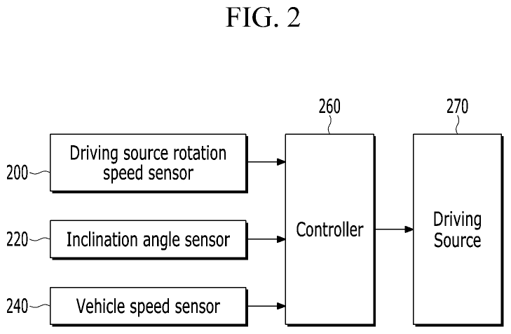

FIG. 1 is a flowchart illustrating a method for determining running resistance of a vehicle according to various exemplary embodiments of the present invention. FIG. 2 is a block diagram for describing a device configured for determining running resistance of a vehicle to which the method for determining running resistance of a vehicle illustrated in FIG. 1 is applied.

Referring to FIG. 1 and FIG. 2, in the receiving step 100, a controller 260 may receive a rotation speed of a driving source (or power source) 270 such as an engine or electric motor configured for driving the vehicle, and an inclination angle (or inclination angle of the vehicle) of a road on which the vehicle runs, the inclination angle being detected by an inclination angle sensor 220. The rotation speed of the driving source may be detected by a driving source rotation speed sensor 200, and provided to the controller 260.

The device configured for determining running resistance of a vehicle may include the driving source rotation speed sensor 200 that detects the rotation speed of the driving source of the vehicle, an inclination angle sensor 220, such as a gravity sensor (G sensor) or an acceleration sensor, that detects an inclination angle of a road on which the vehicle runs, a vehicle speed sensor 240, and the controller 260.

The controller 260 is an electronic control unit (ECU) and may control the overall operation of the device configured for determining running resistance of a vehicle. The controller 260 may be, for example, one or more microprocessors operated by a program (control logic) or hardware (for example, a microcomputer) including the microprocessors, and the program may include a series of instructions for performing the method for determining running resistance of a vehicle according to various exemplary embodiments of the present invention. The instruction may be stored in a memory of the device configured for determining running resistance of a vehicle or the controller 260.

According to step 110, the controller 260 may determine a torque of the driving source based on a rotation speed of the driving source and determine (or estimate) the inclination angle of the road based on the torque of the driving source. The inclination angle of the road according to the torque of the driving source may be stored in the memory of the device configured for determining running resistance of a vehicle or the controller 260, and determined by a test (or experiment).

According to step 120, the controller 260 may determine whether the inclination angle of the road determined according to the torque of the driving source exceeds the inclination angle of the road detected by the inclination angle sensor.

When the inclination angle of the road determined according to the torque of the driving source is equal to or less than the inclination angle of the road detected by the inclination angle sensor, the method for determining running resistance of a vehicle, which is a process, may proceed to step 130, and when the inclination angle of the road determined according to the torque of the driving source exceeds the inclination angle of the road detected by the inclination angle sensor, the method for determining running resistance of a vehicle, which is a process, may proceed to step 140.

According to step 130, the controller 260 may determine that there is no object (e.g., a trailer) towed by the vehicle, and determine the running resistance of the vehicle using the running resistance of the vehicle based on the inclination angle of the road determined according to the torque of the driving source stored in the memory. The running resistance of the vehicle based on the inclination angle of the road determined according to the torque of the driving source may be stored in the memory of the device configured for determining running resistance of a vehicle or the controller 260 and determined by a test (or experiment).

The running resistance of the vehicle may include a rolling resistance which may be mainly generated when the speed of the vehicle is less than a reference value (e.g., 70 (kph)), and air resistance and climbing resistance (or gradient resistance) which may be mainly generated when the speed of the vehicle is greater than or equal to the reference value (e.g., 70 (kph)).

According to step 135, after step 130, the controller 260 may control the driving source 270 or a transmission of the vehicle based on the running resistance of the vehicle. For example, when the running resistance of the vehicle is relatively large (when the running resistance of the vehicle is greater than the reference resistance), the controller 260 may control the driving source to have a relatively large output or torque (control the driving source to have an output greater than the reference output or a torque greater than the reference torque) or control a shift gear of the transmission transmitting the output of the driving source to be a lower gear.

According to step 140, the controller 260 may determine that there is an object towed by the vehicle and correct the inclination angle of the road determined according to the torque of the driving source determined based on the speed of the vehicle. In more detail, when the speed of the vehicle is equal to or greater than the reference value (e.g., 70 (kph)), the controller 260 may increase the inclination angle of the road determined according to the torque of the driving source by the reference inclination angle. The value of the reference inclination angle may increase when a magnitude of an air resistance force of the towed object increases.

According to step 150, the controller 260 may determine the running resistance of the vehicle using the running resistance of the vehicle according to the corrected inclination angle of the road determined based on the torque of the driving source stored in the memory. The running resistance of the vehicle based on the corrected inclination angle of the road determined according to the torque of the driving source may be stored in the memory of the device configured for determining running resistance of a vehicle or the controller 260 and determined by a test (or experiment).

According to step 160, the controller 260 may control the driving source 270 or the transmission of the vehicle based on the running resistance of the vehicle.

Components, “˜units”, blocks, or modules used in various exemplary embodiments of the present invention may be implemented by software such as tasks, classes, sub-routines, processes, objects, execution threads, or programs performed in a predetermined region on a memory or hardware such as a field-programmable gate array (FPGA) or an application-specific integrated circuit (ASIC) and may be implemented by a combination of the software and the hardware. The components, the “˜units”, or the like, may be included in a computer readable storage medium or may be partially dispersed and distributed in a plurality of computers.

Furthermore, the term related to a control device such as “controller”, “control unit”, “control device” or “control module”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present invention. The control device according to exemplary embodiments of the present invention may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may process data according to a program provided from the memory, and may generate a control signal according to the processing result.

The control device may be at least one microprocessor operated by a predetermined program which may include a series of commands for carrying out the method included in the aforementioned various exemplary embodiments of the present invention.

The aforementioned invention can further be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include hard disk drive (HDD), solid state disk (SSD), silicon disk drive (SDD), read-only memory (ROM), random-access memory (RAM), CD-ROMs, magnetic tapes, floppy discs, optical data storage devices, etc. and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present invention, each operation described above may be performed by a control device, and the control device may be configured by multiple control devices, or an integrated single control device.

In various exemplary embodiments of the present invention, the control device may be implemented in a form of hardware or software, or may be implemented in a combination of hardware and software.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A method for determining running resistance of a vehicle, the method comprising:
receiving, by a controller, a rotation speed of a driving source of the vehicle and an inclination angle of a road on which the vehicle runs, the inclination angle being detected by an inclination angle sensor;
determining, by the controller, a torque of the driving source according to the rotation speed of the driving source and determining the inclination angle of the road according to the torque of the driving source;
determining, by the controller, whether the inclination angle of the road determined according to the torque of the driving source exceeds the inclination angle of the road detected by the inclination angle sensor; and
when the controller concludes that the inclination angle of the road determined according to the torque of the driving source is less than or equal to the inclination angle of the road detected by the inclination sensor, determining, by the controller, that there is no object towed by the vehicle, and determining the running resistance of the vehicle based on the inclination angle of the road determined according to the torque of the driving source; and
controlling, by the controller, the driving source or a transmission of the vehicle based on the determined running resistance of the vehicle.

2. The method of claim 1, further including:
determining, by the controller, that there is the object towed by the vehicle and correcting the inclination angle of the road determined according to the torque of the driving source determined based on the speed of the vehicle, when the controller concludes that the inclination angle of the road determined according to the torque of the driving source exceeds the inclination angle of the road detected by the inclination angle sensor; and
determining, by the controller, a running resistance of the vehicle based on the corrected inclination angle of the road determined according to the torque of the driving source.

3. The method of claim 2, wherein the correcting of the inclination angle of the road determined according to the torque of the driving source includes:
increasing, by the controller, the inclination angle of the road determined according to the torque of the driving source by a reference inclination angle when the speed of the vehicle is greater than or equal to a reference value.

4. The method of claim 1, wherein the running resistance of the vehicle based on the inclination angle of the road determined according to the torque of the driving source is prestored in a memory.

5. The method of claim 2, wherein the running resistance of the vehicle according to the corrected inclination angle of the road determined based on the torque of the driving source is prestored in a memory.

6. The method of claim 3, wherein the controller is configured so that a value of the reference inclination angle increases when a magnitude of an air resistance force of the towed object increases.

7. The method of claim 1, wherein the controlling, by the controller, the driving source or a transmission of the vehicle based on the determined running resistance of the vehicle includes controlling the driving source to have an output greater than a reference output or the torque greater than a reference torque or controlling a shift gear of the transmission transmitting the output of the driving source to be a lower gear, when the running resistance of the vehicle is greater than a reference resistance.

8. A non-transitory computer readable storage medium on which a program for performing the method of claim 1 is recorded.

9. A apparatus for determining running resistance of a vehicle, the apparatus comprising:
a driving source rotation speed sensor configured for detecting a rotation speed of a driving source included in the vehicle;
an inclination angle sensor configured for detecting an inclination angle of a road on which the vehicle runs; and
a controller that receives the rotation speed of the driving source detected by the driving source rotation speed sensor and the inclination angle of the road detected by the inclination angle sensor,
wherein the controller is configured to determine a torque of the driving source according to the rotation speed of the driving source, and to determine the inclination angle of the road according to the torque of the driving source,
the controller is configured to determine whether the inclination angle of the road determined according to the torque of the driving source exceeds the inclination angle of the road detected by the inclination angle sensor,
when the controller concludes that the inclination angle of the road determined according to the torque of the driving source is less than or equal to the inclination angle of the road detected by the inclination sensor, the controller is configured to determine that there is no object towed by the vehicle, and is configured to determine the running resistance of the vehicle based on the inclination angle of the road determined according to the torque of the driving source, and
wherein the controller is configured to control the driving source or a transmission of the vehicle based on the determined running resistance of the vehicle.

10. The apparatus of claim 9, wherein
when the controller concludes that the inclination angle of the road determined according to the torque of the driving source exceeds the inclination angle of the road detected by the inclination angle sensor, the controller is configured to determine that there is the object towed by the vehicle, and configured to correct the inclination angle of the road determined according to the torque of the driving source determined based on the speed of the vehicle detected by the vehicle speed sensor, and
the controller is configured to determine a running resistance of the vehicle based on the corrected inclination angle of the road determined according to the torque of the driving source.

11. The apparatus of claim 9, wherein the running resistance of the vehicle based on the inclination angle of the road determined according to the torque of the driving source is prestored in a memory.

12. The apparatus of claim 10, wherein the running resistance of the vehicle according to the corrected inclination angle of the road determined based on the torque of the driving source is prestored in a memory.

13. The apparatus of claim 10, wherein
when the controller concludes that the speed of the vehicle is equal to or greater than a reference value, the controller is configured to increase the inclination angle of the road determined according to the torque of the driving source by a reference inclination angle to correct the inclination angle of the road based on the torque of the driving source.

14. The apparatus of claim 13, wherein the controller is configured so that a value of the reference inclination angle increases when a magnitude of an air resistance force of the towed object increases.

15. The apparatus of claim 10, wherein in the controlling the driving source or the transmission of the vehicle based on the determined running resistance of the vehicle, the controller is configured to control the driving source to have an output greater than a reference output or the torque greater than a reference torque or controlling a shift gear of the transmission transmitting the output of the driving source to be a lower gear, when the running resistance of the vehicle is greater than a reference resistance.
